(19) United States
(12) Patent Application Publication
(10) Pub. No.: US 2012/0114501 A1
(43) Pub. Date: May 10, 2012

(54) Pivoting structural cellular wall for wind energy generation

(76) Inventor: John Rutherford, San Francisco, CA (US)

(21) Appl. No.: 13/135,486

(22) Filed: Jul. 7, 2011

Related U.S. Application Data
(60) Provisional application No. 61/399,267, filed on Jul. 8, 2010.

(51) Int. Cl. F03D 11/04; B23P 17/04

(52) U.S. Cl. 416/244 R; 29/592

(57) ABSTRACT

The present invention relates to a device and method associated with the device. It is a wall for collecting wind energy, holds multiple wind turbines at increased heights, the device also pivots around a central point and keeps the turbines aligned into the direction of the wind. This device can be used to increase the yield of energy collected from the wind and to place wind turbines in stronger winds. The device enables turbines to be located within the structure. The rotation is around a center pivot point with the outer vertexes of the triangle free to move. With respect to the method, the modular cells locate the wind turbines in higher wind speeds. The wind flows around and through the cell structure creating beneficial vortexes. The wind is converted into energy at the turbine, at the conclusion of these steps wind energy is converted into electrical power.

### CROSS REFERENCE TO RELATED APPLICATION

This application claims the benefit of provisional patent application Ser. No. 61/399,267, filed Jul. 8, 2010 by the present inventor, which is incorporated by reference.

### BACKGROUND OF THE INVENTION

1. Field of the Invention

The present invention relates generally to a pivoting structural cellular wall for wind energy generation.

2. Background-Prior Art

| Patent Number | Issue Date | Patentee |
|---|---|---|
| 7,075,189 | 2006 | Heronemus |
| 6,749,399 | 2004 | Heronemus |
| 6,100,600 | 2000 | Pflanz |
| Des 305,419 | 1990 | Korneski |
| 4,550,259 | 1985 | Bertels |
| 4,340,822 | 1982 | Gregg |
| 4,323,331 | 1982 | Schachle |
| 4,220,870 | 1980 | Kelly |
| 4,110,631 | 1978 | Salter |
| 3,883,750 | 1975 | Uzzell |
| 1,345,022 | 1920 | Oliver |

### BACKGROUND-SUMMARY

Currently there are a number of solutions for installing wind turbines. Some of these solutions attempt to install the turbine on top of a single post or truss tower, but these solutions fail to meet the needs of the industry because you can only put one turbine on one tower. This leads to solutions where they just try to put a bigger turbine on a bigger tower. These solutions ignore the benefits of placing multiple turbines within a cellular wall structure and building structures with multiple turbines.

There are numerous alternative designs in prior art which, while imaginative still do not create an advantageous efficient solution. Some designs have multiple turbines rotating on a single tower, some designs have a rotating tower holding multiple turbines and other designs have turbines installed in front of structural elements. The elements that rotate in these prior art designs have the turbines located either directly on axis or closely on axis with the center rotational point. The geometry that they use does not resolve issues of rotational and vibrational instability and simply limits the number of multiple turbines.

It would be desirable to have a device that locates wind turbines higher in stronger winds which results in greater energy density yields. Furthermore, it would also be desirable to have a device that holds multiple wind turbines and rotates all of the turbines at once into the direction of the wind. Still further, it would be desirable to have a device that is lighter, stronger, taller, modular, rotates all of the turbines as a group and locates more turbines closer to one another. Therefore, there currently exists a need in the industry for a device and associated method that holds wind turbines in an improved wind speed location, in multiple groups and geometrically aligned to increase energy yields.

The design described in this application is a lagging pivot geometry which is inherently stable. It is a further advantage to pivot as a triangular pie shaped structure as the pivot point always remains in a natural tension position, much like a ship pivots into the wind at anchor.

### SUMMARY OF THE INVENTION

The present invention advantageously fills the aforementioned deficiencies by providing a Pivoting Structural Cellular Wall For Wind Energy Generation which provides an increase in electrical energy yield per wind farm.

The present invention is a wall for collecting wind energy, which is made up of the following components, foundations, compressive structural members, tensegrity cable structural members and hexagonal triangular modules. These structural members are connected in triangular and hexagonal patterns to create the modules. The modules have a cylindrical void space in their center and are arranged to maximize the density of turbines in relation to one another. The modules are connected as follows, they are stacked geometrically upon one another to form a wall as a continuous structural element. The modules have ducted fan wind turbines that are located within the cylindrical void space of each module. The base structure forms a triangle with the pivot point at one vertex and with the outer vertexes of the triangle free to move in a 360 degree circular pattern.

The present invention may also have one or more of the following: 1) The modules may be either all rigid structural members or a combination of rigid members and tensegrity cable members., 2) The wall may be secured by cables to the pivot point of the triangular base., 3) The cellular wall modules may be self-erecting and/or prefabricated., 4) The entire structure may be land based, have a fixed pivot point, have wheels which ride on a circular track., 5) The entire structure may be shallow water based, have a fixed pivot point from the sea bed and have pontoons which float in a circular track., 6) The entire structure may be a deep water based trimaran, have an anchored pivot point from the sea bed and have pontoon hulls which float in a circular pattern as a ship.

The present invention is unique when compared with other known devices and solutions because the present invention provides: (1) The location of turbines in higher wind speeds at higher elevations; (2) The location of turbines within a structure that has a clear wind path and faces into the wind; (3) The pivoting cellular wall has a wide triangular base with a beneficial width to height shape ratio; (4) The pivoting cellular wall has a wide triangular base with a fixed pivot; (5) The rotation of the entire structure and that turbines can be individually mounted in a fixed condition and (6) The use of multiple wind turbines within a single modular cellular wall structure.

The present invention is unique in that it is structurally different from other known devices or solutions. More specifically, the present invention is unique due to the presence of: (1) It's hexagonal and triangular geometry; (2) Tensegrity cable members; (3) It's minimal horizontal wind disturbance shape; (4) The creation of the cylindrical void area for the turbines within the cellular structure; (5) The structure locates turbines close to one another in a dense packed grid; (6) The pivoting cellular wall has a wide triangular base with a fixed pivot which keeps the pivot in tension and the outlying vertexes of the base in compression; and (7) It's wide height to width ratio. Furthermore, the process associated with the aforementioned invention is likewise unique and different from known processes and solutions. More specifically, the present invention process owes its uniqueness to the fact that it: (1) Minimizes wind speed disturbance and turbulence; (2) Wind flows around structural members in a minimally disturbed state; (3) Wind flows cause the entire structure to pivot and stay facing into the wind and (4) The wall can have increased flex and sway.

Among other things, it is an object of the present invention to provide a pivoting structural cellular wall for wind energy generation that does not suffer from any of the problems or deficiencies associated with prior solutions.

It is still further an object of the present invention to be lighter and more economical to construct.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 Is a perspective diagram, front view of a the entire Pivoting Structural Cellular Wall For Wind Energy Generation

FIG. 2a Is a perspective diagram, front view of a cellular structural wall in a flat layout.

FIG. 2b Is a perspective diagram, front view of a cellular structural wall in a shaped and staggered layout.

FIG. 3a Is a perspective diagram, angle view of an individual cellular module.

FIG. 3b Is a perspective diagram, angle view of an individual cellular module.

FIG. 4a Is a perspective diagram, angle view of an individual cellular module with tensegrity and solid structural members.

FIG. 4b Is an elevation diagram of a group of cellular modules with tensegrity interconnections.

FIG. 5 Shows the process and method of wind flow.

FIG. 6a Is a perspective diagram, angle view of the wheels and circular track.

FIG. 6b Is a section diagram of a wing foil shaped structural member.

FIG. 7 Is a perspective diagram of multiple Pivoting Structural Cellular Walls For Wind Energy Generation in a wind farm.

### DETAILED DESCRIPTION OF THE INVENTION

The present invention is directed to be a Pivoting Structural Cellular Wall For Wind Energy Generation

In its most complete form, the present invention device is made up of the following components, foundations, compressive structural members, tensegrity cable structural members and hexagonal triangular modules. These members are arranged into triangular or hexagonal shapes with welded, bolted or cable connections. These shapes are then arranged into three dimensional modules which are also based on hexagonal and triangular geometry. The modules are unitized to resolve structural forces within themselves and as a component of the larger structural grid assembly. The stacking of modules forms a complete structural wall. The top/outer modules have additional structural members and the additional of role of resolving tensegrity forces when tensegrity cables are used in interior modules. It should further be noted that: while the main structural materials are steel and steel cable other structural materials may be used in their place. Additionally, rigid structural members can be shaped to reduce wind interference and that these shapes can produce beneficial wind vortexes with localized higher wind speeds. The cellular wind wall is located on a structural truss triangular base. This base has a fixed pivot point and wheels at the outer vertexes of the triangular base, enabling 360 degree rotation. The wheels rotate upon a circular track, the entire structure will self align towards the wind direction due to wind pressure. The most complete form of performing the method associated with the present invention device consists of the following steps, the modules are designed to minimize horizontal wind interference. The wind encounters the wall, it flows around small diameter cables and flows in an undisturbed state to the wind turbine located in the cylindrical void of the module, the wind is then converted by the turbine to electricity. It should further be noted that: due to the use of ducted fan multiple turbines that the wall in it's entirety may be designed for an increased amount of flexure or sway.

Referring to the figures:

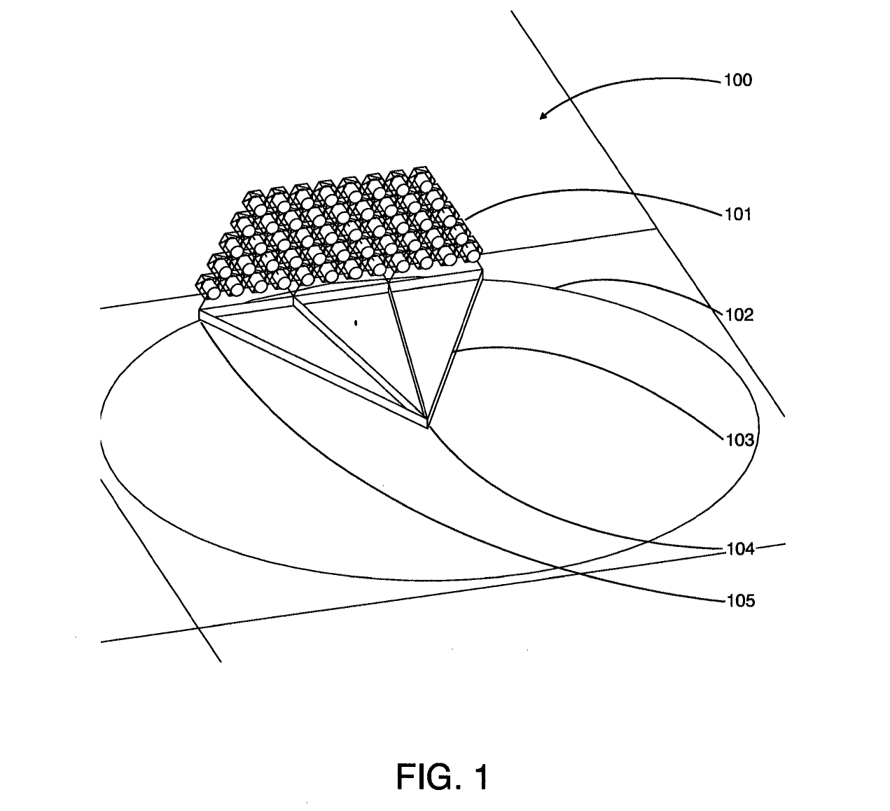

A description of the elements shown in FIG. 1 is as follows. The entire invention (100) is comprised of the following components. The hexagonal cell modules are arranged into a wall (101) which is a rigid structural shape which permits undisturbed airflow to the turbine. The circular track upon which the wind wall rotates (102). The triangular base trusses (103) are connected to the pivot point (104). The outer vertexes of the triangular base (105) are free to move in a circular pattern and have wheels or floats. The design provides stiffening at the module to module interface and the maximum amount of free airflow at the center of the cell from which the turbine can produce power.

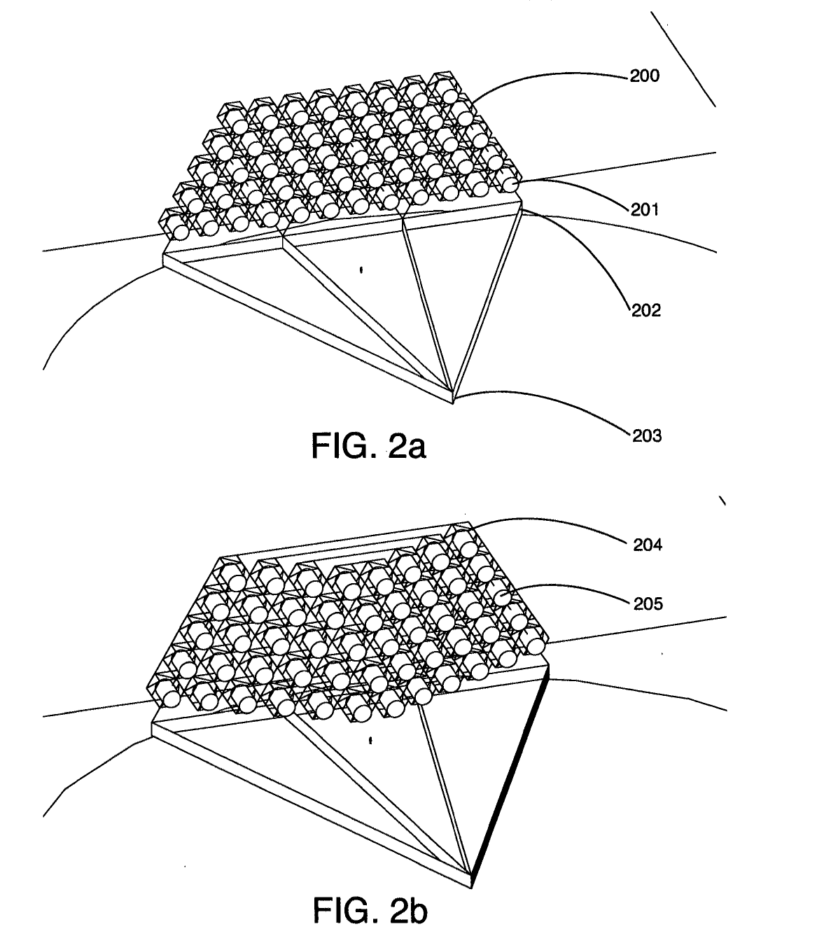

A description of the elements shown in FIGS. 2a and 2b is as follows. The hexagonal cell modules are arranged into a wall (200, 204) which is a rigid structural shape which permits undisturbed airflow to the turbine. The wall can be various shapes either flat or shaped and staggered. The turbines are located within the clear airflow cylinder areas (201, 205). The triangular base trusses are connected to the pivot point (203). The outer vertexes of the triangular base (202) are free to move in a circular pattern and have wheels or floats.

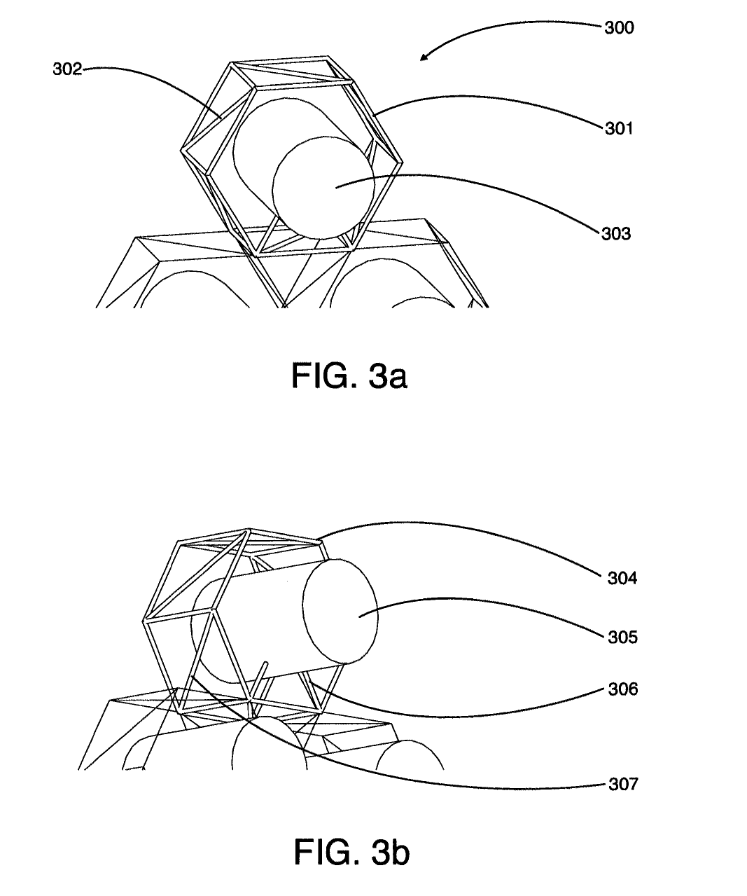

A description of the elements shown in FIGS. 3a and 3b is as follows. The cellular hexagonal modules (300). The hexagonal elements (301, 304) are joined by cross members (302, 307) to create a module. The turbine and the cylindrical area for the turbine location (303, 305) is located within the cellular hexagonal module. The cylinder area (303, 305) is not an object but a representation of the zone of clear airflow within which the turbine is located. The turbines are connected to the module by struts (306). By stacking cellular hexagonal modules (300) the wall structure is formed.

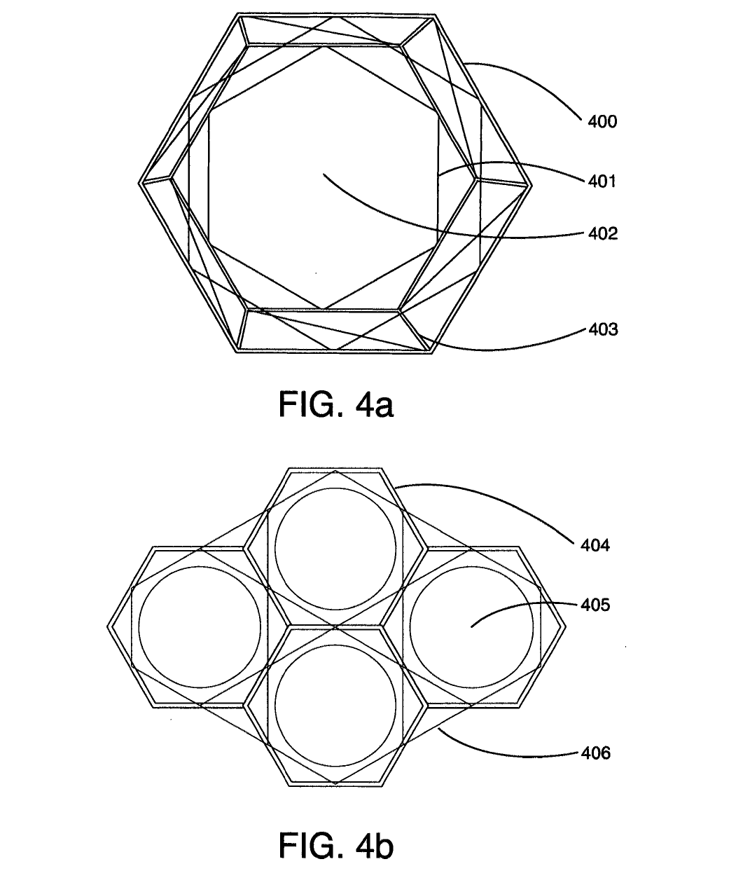

A description of the elements shown in FIGS. 4a and 4b is as follows. The cellular hexagonal modules are comprised of solid structural members (400, 404) and tensegrity cable members (401,406). The solid cross members (403) connect the front face to the back face. The cylindrical void space (402, 405) is the clear airflow area where the turbine is located. Additionally, FIG. 4b shows in elevation the tight packing of cellular modules with the cross connection of tension cables. The tension cables (406) can be placed closer to the turbine zone (402,405) because of their minimal cross section. By stacking cellular hexagonal modules the wall structure is formed.

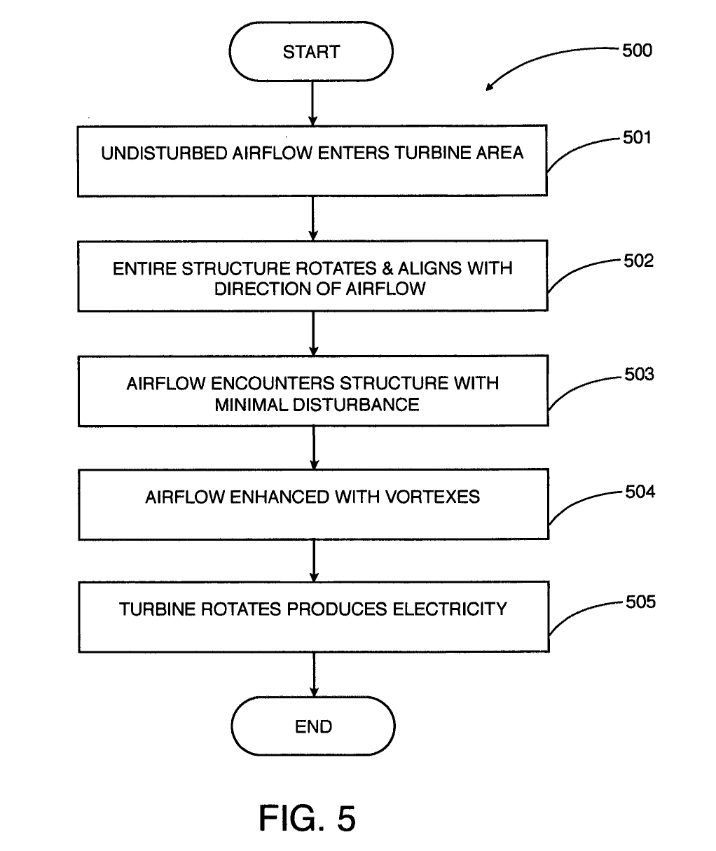

A description of the elements shown in FIG. 5 is as follows. The steps of the airflow process (500, 501, 502, 503, 504, 505) a clear cylindrical area of airflow for the location of the turbine within the module. The modules create vortexes that further enhance airflow. The entire structure rotates to stay aligned to the wind direction.

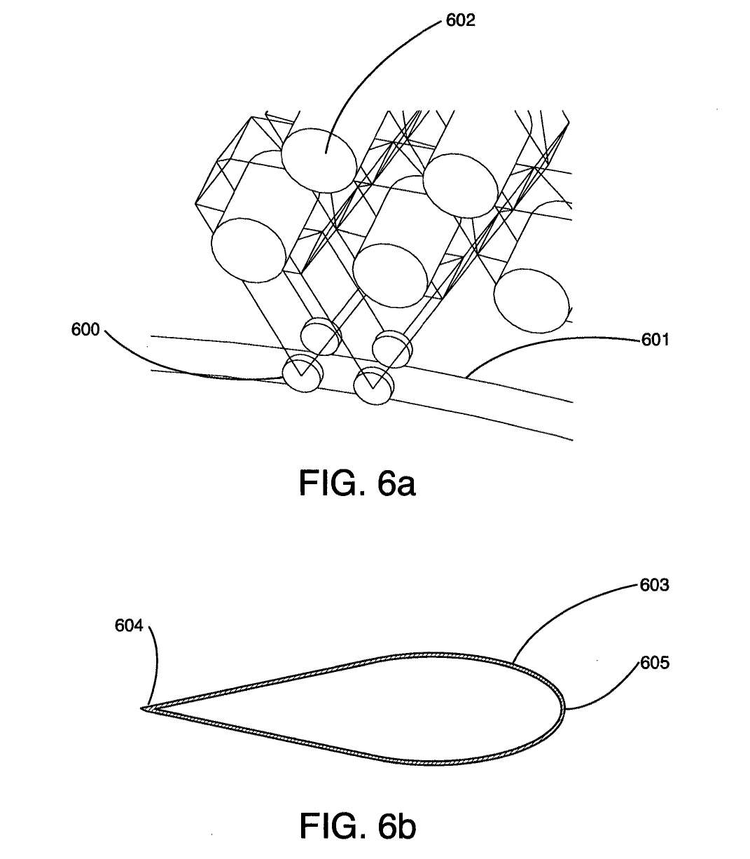

A description of the elements shown in FIG. 6a is as follows. The hexagonal cells (602) form the wall and bear upon the wheels (600). The wheels roll along the tracks (601). This allows the entire structure to freely rotate.

A description of the elements shown in FIG. 6b, airfoil section, is as follows. The airfoil (603) has a leading edge (605) and a trailing edge (604). The airfoil is the cross section of the profile of selected solid structural members.

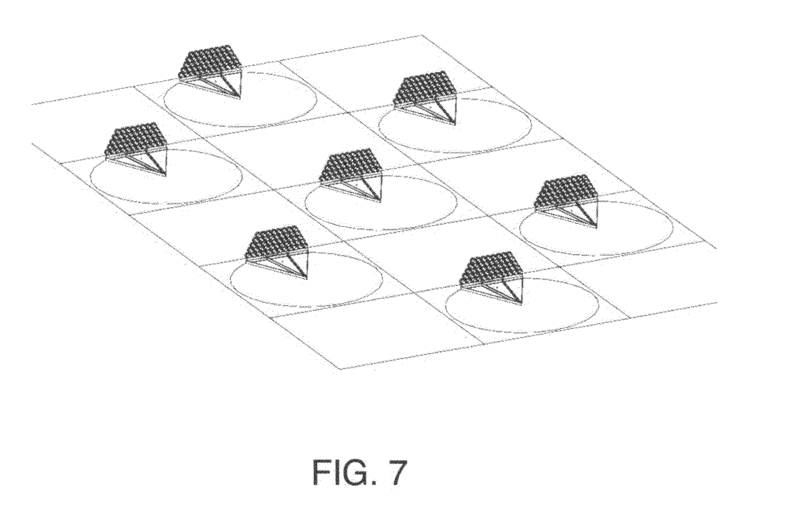

A description of the elements shown in FIG. 7 is as follows. The pivoting structural cellular wall for wind energy generation is shown in a multiple unit wind farm arrangement. The wind farm shows a staggered arrangement of pivoting wind wall structures.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

### ADVANTAGES & CONCLUSIONS

The structure locates wind turbines higher in stronger winds which results in greater energy density yields. The device that holds multiple wind turbines and rotates all of the turbines at once into the direction of the wind. The device is lighter, stronger, taller, modular, rotates all of the turbines as a group and locates more turbines closer to one another. The device and associated method that holds wind turbines in an improved wind speed location, in multiple groups, geometrically aligned and densely arranged to increase energy yields. The turbines are located within the structure in an area of clear undisturbed airflow.

The device is a lagging pivot geometry which is inherently stable. It pivots as a triangular pie shaped structure where the pivot point always remains in a tension position, it positions itself into the wind.

I claim:

1. In an structure of the type that is a wall holding energy generating wind turbines and the wall is located upon a triangular base with a pivot point. The entire structure is free to move around the pivot point.

2. The wall structure of claim 1 is modular and of a type with voids within which the wind turbines are located.

3. The pivot point of claim 1 is a fixed structure with the wall supported by wheels.

4. The pivot point of claim 3 is an anchored floating structure with the wall supported by floats.

5. The triangular base of claim 1 locates the wall over the free to rotate corners of said base. The wall location is offset from the pivot point over the base of the triangular base between the two said free to rotate corners.

6. A method of locating wind turbines in a clear airflow location at higher elevations where airflow is stronger and has a higher energy yield.

7. A method in claim 6 where airflow is minimally disturbed by a minimally sized airfoil shaped modular structure.

8. In a modular wall structure which is composed of cables in tension and airfoil shaped rigid structural members.

9. Structural members in claim 6 are steel, aluminum, stainless steel, and/or carbon fiber tension and compression load bearing members with airfoil shapes.
